(19) United States
(12) Patent Application Publication
(10) Pub. No.: US 2017/0241636 A1
(43) Pub. Date: Aug. 24, 2017

(54) Emergency Assistance Assembly

(71) Applicants: Haden Mosley, Forest, MS (US); Adrianna Mosley, Forest, MS (US)

(72) Inventors: Haden Mosley, Forest, MS (US); Adrianna Mosley, Forest, MS (US)

(21) Appl. No.: 15/048,249

(22) Filed: Feb. 19, 2016

(51) Int. Cl. F21V 33/00; G01S 19/17; F21L 4/04; F21L 14/00; H04B 1/3827; F21L 4/08

(52) U.S. Cl. CPC F21V 33/0064; H04B 1/3827; F21V 33/0056; F21L 4/08; F21L 4/04; F21L 14/00; G01S 19/17

(57) ABSTRACT

An emergency assistance assembly includes a housing that may be carried. A radio is coupled to the housing. The radio is in electrical communication with an extrinsic communications network. A compass is coupled to the housing to indicate Cardinal directions with respect to Earth. A pair of lighting units is provided and each of the lighting units is movably coupled to the housing. Each of the lighting units emits light in a selected direction with respect to the housing. Each of the lighting units is positioned on an associated one of the first lateral side and the second lateral side.

### BACKGROUND OF THE DISCLOSURE

Field of the Disclosure

The disclosure relates to emergency devices and more particularly pertains to a new emergency device for providing emergency lighting and gps location assistance.

### SUMMARY OF THE DISCLOSURE

An embodiment of the disclosure meets the needs presented above by generally comprising a housing that may be carried. A radio is coupled to the housing. The radio is in electrical communication with an extrinsic communications network. A compass is coupled to the housing to indicate Cardinal directions with respect to Earth. A pair of lighting units is provided and each of the lighting units is movably coupled to the housing. Each of the lighting units emits light in a selected direction with respect to the housing. Each of the lighting units is positioned on an associated one of the first lateral side and the second lateral side.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a front perspective view of an emergency assistance assembly according to an embodiment of the disclosure.

FIG. 2 is a top view of an embodiment of the disclosure.

FIG. 3 is a front view of an embodiment of the disclosure.

FIG. 4 is a left side view of an embodiment of the disclosure.

FIG. 5 is a back view of an embodiment of the disclosure.

FIG. 6 is a schematic view of an embodiment of the disclosure.

### DESCRIPTION OF THE PREFERRED EMBODIMENT

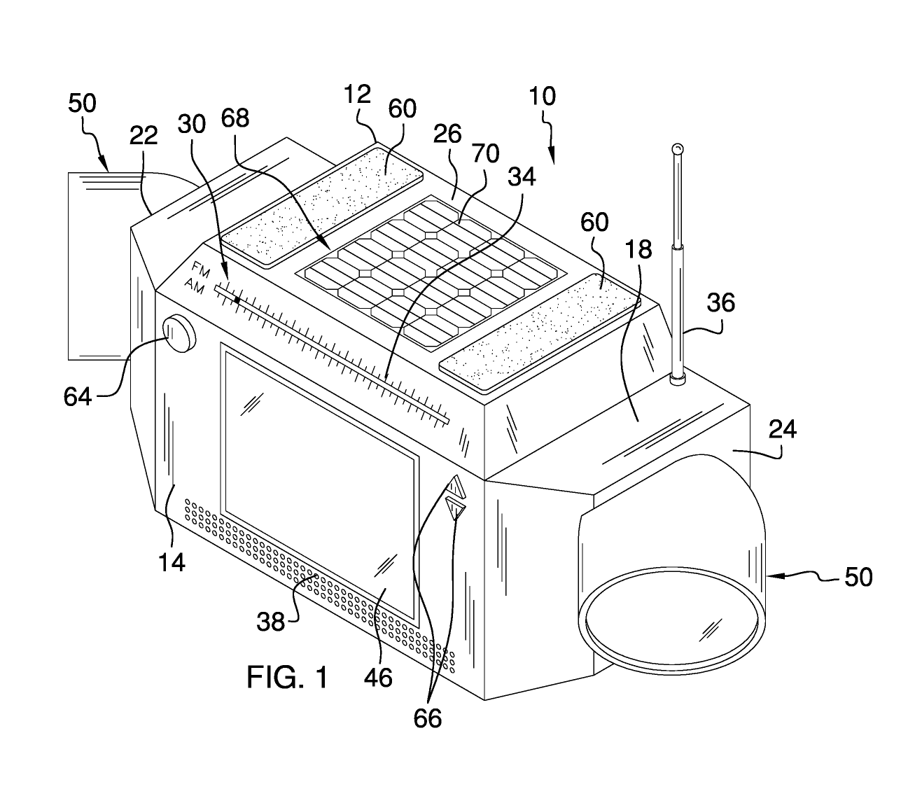

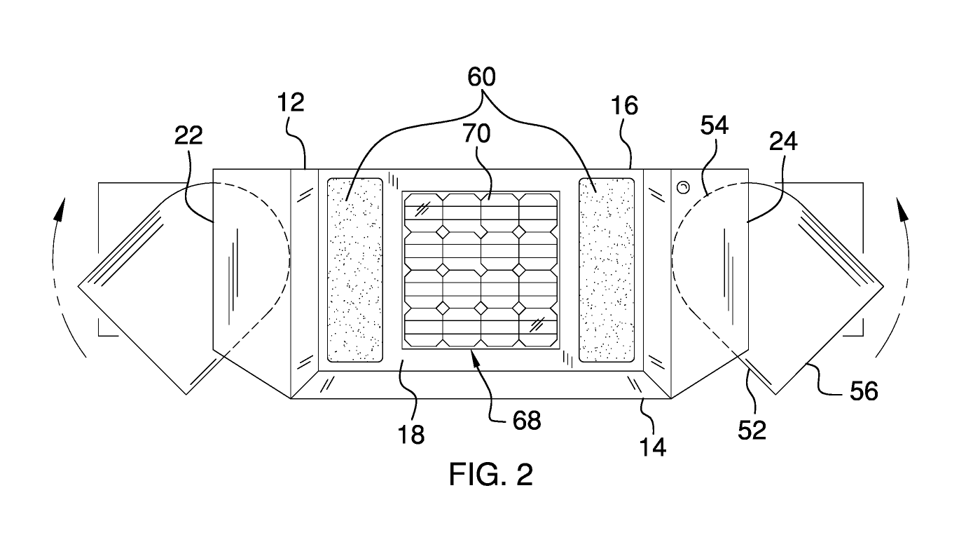

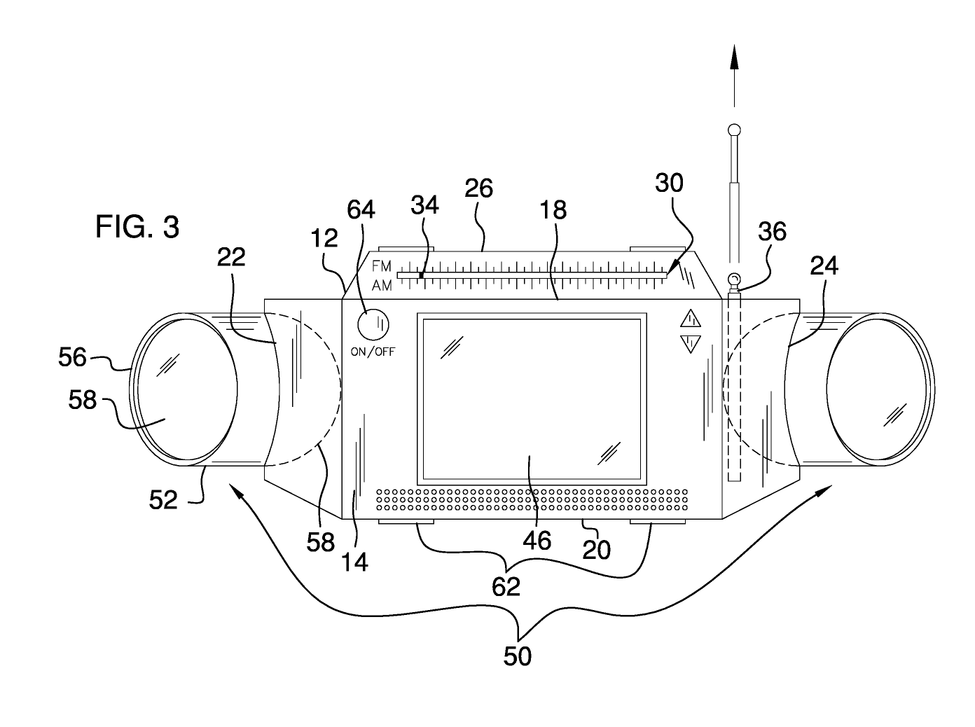

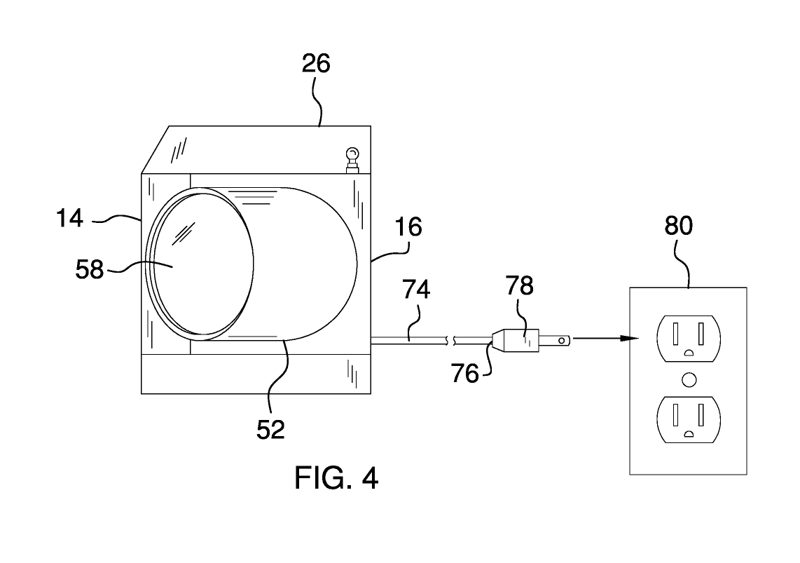

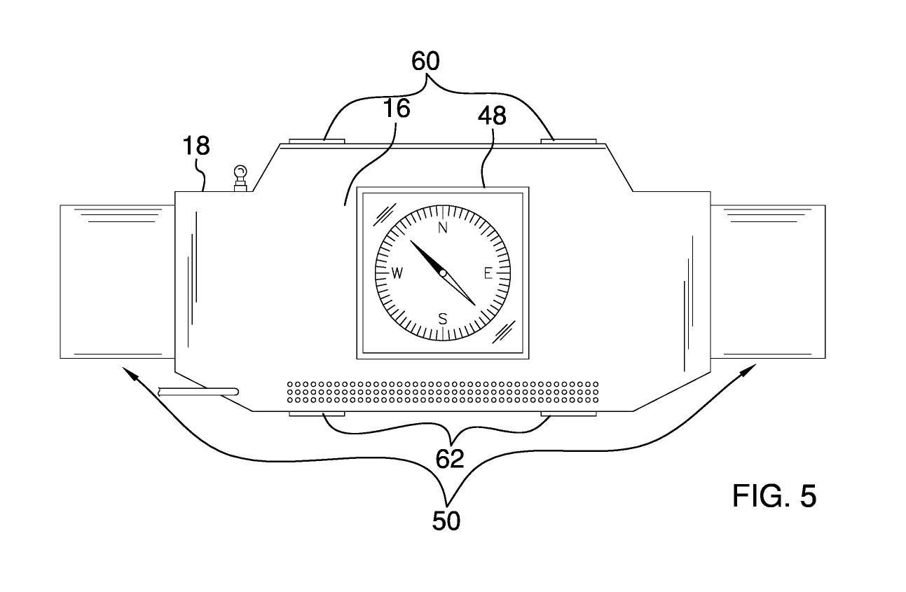

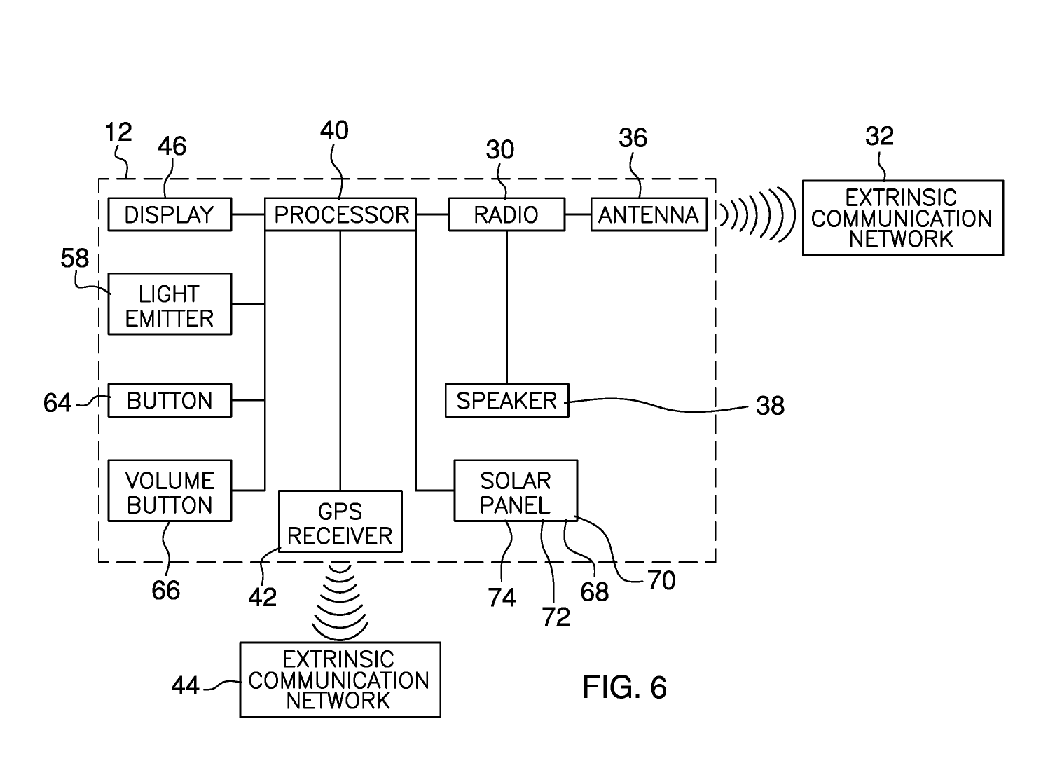

With reference now to the drawings, and in particular to FIGS. 1 through 6 thereof, a new emergency device embodying the principles and concepts of an embodiment of the disclosure and generally designated by the reference numeral 10 will be described.

As best illustrated in FIGS. 1 through 6, the emergency assistance assembly 10 generally comprises a housing 12 that may be carried. The housing 12 has a front side 14, a back side 16, a top side 18, a bottom side 20, a first lateral side 22 and a second lateral side 24. The top side 18 may have a raised portion 26 and the raised portion 26 may be centrally positioned on the top side 18. The front side 14 may angle rearwardly between a middle section 28 of the front side 14 and each of the first lateral side 22 and the second lateral side 24.

A radio 30 is coupled to the housing 12. The radio 30 may be in electrical communication with an extrinsic communications network 32 thereby facilitating the radio 30 to emit audible sounds received from the extrinsic communications network 32. The extrinsic communications network 32 may comprise a radio broadcast station or the like.

The radio 30 includes a dial 34 that may be positioned on the front side 14 of the housing 12. The radio 30 includes an antenna 36 this is selectively extendable upwardly from the top side 18. The radio 30 may comprise an AM/FM radio or the like. A speaker 38 is coupled to the housing 12 and the speaker 38 may be positioned on the front side 14. The speaker 38 is electrically coupled to the radio 30.

A processor 40 is positioned within the housing 12 and the radio is electrically coupled to the processor 40. A gps receiver 42 is coupled to the housing 12. The gps receiver 42 is may be in electrical communication with an extrinsic communications network 44. Thus, the gps receiver 42 may receive a location of the housing 12 with respect to Earth. The gps receiver 42 is electrically coupled to the processor 40. The extrinsic communications network 44 associated with the gps receiver 42 may comprise a global positioning satellite or the like.

A display 46 is coupled to the housing 12 and the display 46 may be positioned on the front side 14. The display 46 is electrically coupled to the processor 40 and the display 46 may display geographical information communicated by the gps receiver 42. Thus, the display 46 communicates the location of the housing 12 with respect to Earth. The display 46 may comprise an LCD or the like.

A compass 48 is coupled to the housing 12 and the compass 48 indicates Cardinal directions with respect to Earth. The compass 48 may be positioned on the back side 16 of the housing 12. The compass 48 may comprise a magnetic compass or the like.

A pair of lighting units 50 is provided. Each of the lighting units 50 is movably coupled to the housing 12. Each of the lighting units 50 emits light in a selected direction with respect to the housing 12. Each of the lighting units 50 is positioned on an associated one of the first lateral side 22 and the second lateral side 24.

Each of the lighting units 50 comprises a cup 52 that has a back end 54 and an open end 56. The back end 54 of the cup 52 is rotatably coupled to the housing 12 such that the open end 56 is directed away from the housing 12. The cup 52 is positionable at a selected angle with respect to the housing 12. Thus, a line extending through the back end 54 and the open end 56 defines the selected angle with respect to a line extending through the first lateral side 22 and the second lateral side 24 of the housing 12.

A light emitter 58 is positioned within the cup 52 and the light emitter 58 emits light outwardly from the open end 56. The light emitter 58 emits light at the selected angle when the cup 52 is manipulated. The light emitter 58 is electrically coupled to the processor 40. The light emitter 58 may comprise an LED or the like.

A pair of first grips 60 is provided. Each of the first grips 60 is coupled to the housing 12 and each of the first grips 60 may be gripped. Each of the first grips 60 is positioned on the top side 18 and the first grips 60 are spaced apart from each other. Each of the first grips 60 may be comprised of a resiliently compressible material thereby enhancing gripping the housing 12. Each of the first grips 60 may be positioned on the raised portion 26 of the housing 12.

A pair of second grips 62 is provided. Each of the second grips 62 is coupled to the housing 12 and each of the second grips 62 may be gripped. Each of the second grips 62 may be positioned on the bottom side 20 and the second grips 62 are spaced apart from each other. Each of the second grips 62 may be comprised of a resiliently compressible material thereby enhancing gripping the housing 12.

A button 64 is coupled to the housing 12 and the button 64 may be manipulated. The button 64 is electrically coupled to the processor 40 such that the button 64 turns the processor 40 on and off. The button 64 may be positioned on the front side 14 of the housing 12. A pair of volume buttons 66 is coupled to the housing 12. Each of the volume buttons 66 is electrically coupled to the radio 30. Thus, each of the volume buttons 66 adjusts a volume of the radio 30.

A power supply 68 is coupled to the housing 12 and the power supply 68 is electrically coupled to the processor 40. The power supply 68 comprises a solar panel 70 that is positioned on the top side 18. The solar panel 70 may be positioned between the first grips 60 on the raised portion 26. Thus, the solar panel 70 may be exposed to sunlight thereby facilitating the solar panel 70 to generate an electrical current. The solar panel 70 may be a solar panel of any conventional design.

The power supply 68 further includes at least one battery 72. The at least one battery 72 is electrically coupled to the solar panel 70 such that the solar panel 70 charges the at least one battery 72. The at least one battery 72 is positioned within the housing 12. A power cord 74 extends outwardly from the housing 12 and the power cord 74 has a distal end 76 with respect to the housing 12. The distal end 76 has a plug 78 that is electrically coupled thereto and the plug 78 may be electrically coupled to a power source 80. The power source 80 may comprise an electrical outlet or the like.

In use, housing 12 may be carried in a remote location. The gps receiver 42 facilitates a user to avoid getting lost in the remote location. The compass 48 facilitates the user to orient themselves with respect to the Cardinal directions. Each of the lighting units 50 is manipulated to emit light in a selected direction thereby enhancing visibility in darkness. The housing 12 is positioned to be exposed to sunlight thereby facilitating the solar panel 70 to charge the at least one battery 72. The housing 12 may be carried indoors and the plug 78 may be electrically coupled to the power source 80.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An emergency assistance assembly comprising:
a housing being configured to be carried;
a radio being coupled to said housing, said radio being configured to be in electrical communication with an extrinsic communications network thereby facilitating said radio to emit audible sounds received from the extrinsic communications network;
a compass being coupled to said housing wherein said compass is configured to indicate Cardinal directions with respect to Earth; and
a pair of lighting units, each of said lighting units being movably coupled to said housing wherein each of said lighting units is configured to emit light in a selected direction with respect to said housing, each of said lighting units being positioned on an associated one of said first lateral side and said second lateral side.

2. The assembly according to claim 1, further comprising:
a processor being positioned within said housing; and
a gps receiver being coupled to said housing, said gps receiver being configured to be in electrical communication with an extrinsic communications network thereby facilitating said gps receiver to receive a location of said housing with respect to Earth, said gps receiver being electrically coupled to said processor.

3. The assembly according to claim 2, further comprising a display being coupled to said housing, said display being electrically coupled to said processor wherein said display is configured to display geographical information communicated by said gps receiver thereby facilitating said display to communicate the location of said housing with respect to Earth.

4. The assembly according to claim 1, wherein each of said lighting units comprises a cup having a back end and an open end, said back end of said cup being rotatably coupled to said housing such that said open end is directed away from said housing, said cup being positionable at a selected angle with respect to said housing such that a line extending through said back end and said open end defines the selected angle with respect to a line extending through a first lateral side and a second lateral side of said housing.

5. The assembly according to claim 4, further comprising:
a processor; and
a light emitter being positioned within said cup wherein said light emitter is configured to emit light outwardly from said open end, said light emitter being configured to emit light at the selected angle when said cup is manipulated, said light emitter being electrically coupled to said processor.

6. The assembly according to claim 1, further comprising:
a first pair of grips, each of said first pair of grips being coupled to said housing wherein each of said first pair of grips is configured to be gripped, each of said first pair of grips being positioned on a top side of said housing; and
a second pair of grips, each of said second pair of grips being coupled to said housing wherein each of said second pair of grip is configured to be gripped, each of said second pair of grips being positioned on a bottom side of said housing.

7. The assembly according to claim 1, further comprising:
a processor; and
a power supply being coupled to said housing, said power supply being electrically coupled to said processor, said power supply comprising:
a solar panel being positioned on a top side of said housing wherein said solar panel is configured to be exposed to sunlight thereby facilitating said solar panel to generate an electrical current,
at least one battery being electrically coupled to said solar panel such that said solar panel charges said at least one battery, and
a power cord extending outwardly from said housing, said power cord having a distal end with respect to said housing, said distal end having a plug being electrically coupled thereto, said plug being configured to be electrically coupled to a power source.

8. An emergency assistance assembly comprising:
a housing being configured to be carried, said housing having a front side, a back side, a top side, a bottom side, a first lateral side and a second lateral side;
a radio being coupled to said housing, said radio being configured to be in electrical communication with an extrinsic communications network thereby facilitating said radio to emit audible sounds received from the extrinsic communications network;
a processor being positioned within said housing;
a gps receiver being coupled to said housing, said gps receiver being configured to be in electrical communication with an extrinsic communications network thereby facilitating said gps receiver to receive a location of said housing with respect to Earth, said gps receiver being electrically coupled to said processor;
a display being coupled to said housing, said display being electrically coupled to said processor wherein said display is configured to display geographical information communicated by said gps receiver thereby facilitating said display to communicate the location of said housing with respect to Earth;
a compass being coupled to said housing wherein said compass is configured to indicate cardinal directions with respect to Earth;
a pair of lighting units, each of said lighting units being movably coupled to said housing wherein each of said lighting units is configured to emit light in a selected direction with respect to said housing, each of said lighting units being positioned on an associated one of said first lateral side and said second lateral side, each of said lighting units comprising:
a cup having a back end and an open end, said back end of said cup being rotatably coupled to said housing such that said open end is directed away from said housing, said cup being positionable at a selected angle with respect to said housing such that a line extending through said back end and said open end defines the selected angle with respect to a line extending through said first lateral side and said second lateral side of said housing, and
a light emitter being positioned within said cup wherein said light emitter is configured to emit light outwardly from said open end, said light emitter being configured to emit light at the selected angle when said cup is manipulated, said light emitter being electrically coupled to said processor;
a first pair of grips, each of said first pair of grips being coupled to said housing wherein each of said first pair of grips is configured to be gripped, each of said first pair of grips being positioned on said top side;
a second pair of grips, each of said second pair of grips being coupled to said housing wherein each of said second pair of grip is configured to be gripped, each of said second pair of grips being positioned on said bottom side;
a button being coupled to said housing wherein said button is configured to be manipulated, said button being electrically coupled to said processor such that said button turns said processor on and off; and
a power supply being coupled to said housing, said power supply being electrically coupled to said processor, said power supply comprising:
a solar panel being positioned on said top side wherein said solar panel is configured to be exposed to sunlight thereby facilitating said solar panel to generate an electrical current,
at least one battery being electrically coupled to said solar panel such that said solar panel charges said at least one battery, and
a power cord extending outwardly from said housing, said power cord having a distal end with respect to said housing, said distal end having a plug being electrically coupled thereto, said plug being configured to be electrically coupled to a power source.
